(19) United States
(12) Patent Application Publication
(10) Pub. No.: US 2025/0282177 A1
(43) Pub. Date: Sep. 11, 2025

(54) RADIALLY INNER ANNULAR ELEMENT OF A WHEEL HUB PROVIDED WITH FRONT TOOTHING FOR TRANSMITTING TORQUE

(71) Applicant: AKTIEBOLAGET SKF, GOTEBORG (SE)

(72) Inventors: Alessandro FERRERO, Torino (IT); Fulvio Carlo NICASTRI, Garzigliana (IT); Antonio RUIU, Collegno (IT); Luca BIANCONE, Venaria Reale (IT)

(21) Appl. No.: 19/066,274

(22) Filed: Feb. 28, 2025

(30) Foreign Application Priority Data
Mar. 8, 2024 (IT) 102024000005239

(51) Int. Cl. B60B 35/12; B60B 27/00; B60B 27/02

(52) U.S. Cl. CPC B60B 35/128; B60B 27/0026; B60B 27/0094; B60B 27/02; B60B 27/0005

(57) ABSTRACT

An annular element of a wheel hub is provided with a front toothing for transmitting torque and including a plurality of teeth extending radially between a first diameter and a second diameter of the front toothing and having ridges. A first end of the teeth extend to a third diameter of the front toothing at which the teeth have a maximum height and a second end of the teeth extend to a fourth diameter of the front toothing at which the teeth have a minimum height. The ridges each have a section at which the teeth have a straight radial profile and is rounded. A ratio between the third and first diameters is greater than 0.9.

### CROSS-REFERENCE

This application claims priority to Italian patent application no. 102024000005239 filed on Mar. 8, 2024, the contents of which are fully incorporated herein by reference.

### BACKGROUND OF THE INVENTION

The present invention relates to wheel hubs for vehicles, and more particularly to a radially inner annular element of a wheel hub.

Wheel hubs for vehicles typically include an inner ring of a rolling bearing forming a stub axle having a first flanged end and a second end opposite the first end including an upset collar. The collar is designed to receive, by pressing and resulting plastic deformation, a front toothing or side face spline which is required to mechanically connect with, and transmit motion from, a constant velocity joint of the transmission system of a vehicle.

More specifically, in wheel hubs of this type, the front toothing is intended to couple the inner ring of the wheel hub, i.e. the rolling bearing, in abutment with a corresponding front toothing of an outer ring of a constant velocity joint, to ensure torque transmission from the constant velocity joint to the inner ring of the wheel hub, which carries a wheel of the vehicle via the flanged end thereof. Such a coupling is described in U.S. Pat. No. 4,893,960.

In this type of coupling, the amount of transmissible torque, which is required to be increasingly greater in modern applications, is primarily related to the radial and axial dimensions of the teeth of the front toothing, since the width of the lateral surface of the flanks of the teeth that can transmit torque depends on these dimensions. Previously, in order to increase these dimensions and thus the amount of transmissible torque, it was necessary to increase the radially outer diameter of the toothing (and potentially also the radially inner diameter thereof), and consequently of the radially inner annular element of the wheel hub carrying the front toothing, which results in an undesirable increase in dimensions and weight of the wheel hub.

This problem is further aggravated by the fact that the aforementioned front toothing or “side face spline” is normally obtained by plastic deformation of a first annular portion of the inner ring of the rolling bearing, the first portion forming the stub axle of the wheel hub, as well as the collar thereof, the collar being upset against a small inner ring (“SIR”) driven onto the stub axle of the wheel hub and normally forming a second annular portion of the inner ring of the rolling bearing.

On one hand, such an arrangement requires that the inner ring and the upset collar is thick enough to withstand the mechanical working stresses, thereby imposing dimensional limits on the maximum permissible radial and axial dimensions of the front toothing. On the other hand, incorrect coupling between the front toothing of the inner annular element of the wheel hub and the toothing of the constant velocity joint may arise during use as a result of nonoptimal dimensions of the front toothing of the inner annular element of the wheel hub and/or imperfections in the shape of the teeth, which may be related not only to the method used to form the teeth by plastic deformation, but also to failure to optimize the dimensioning of the teeth and/or the upset collar, on account of the aforementioned dimensional limits.

### SUMMARY OF THE INVENTION

The present invention is therefore intended to provide a radially inner annular element of a wheel hub, consisting in particular of an inner ring (or a part thereof) of a rolling bearing of the wheel hub, provided with front toothing for transmitting torque, that does not have the drawbacks of the prior art, and in particular that enables vehicle wheel hubs to be made with relatively high transmissible torques while being smaller and more lightweight.

The invention is also intended to provide a driven wheel hub of a vehicle, i.e. a wheel hub intended to receive a drive wheel of the vehicle, that is smaller and more lightweight, and that has a maximum transmissible torque that is greater than wheel hubs in the prior art, for the same dimensions.

The invention is also intended to ensure, when in use, a correct “soft” coupling between the toothing of the wheel hub and the toothing of a constant velocity joint of the transmission of a vehicle.

The invention therefore provides a radially inner annular element of a wheel hub, in particular consisting of at least part of an inner ring of a rolling bearing, provided with front toothing for transmitting torque, and an associated driven wheel hub, as defined in the attached claims.

### BRIEF DESCRIPTION OF THE SEVERAL VIEWS OF THE DRAWINGS

Further features and advantages of the present invention are set out more clearly in the following description of non-limiting embodiments thereof, provided with reference to the figures in the attached drawings, in which:

FIG. 1 is a schematic view in elevation and longitudinal cross-section of a driven wheel hub made according to the invention and designed to be coupled, when in use, with torque transmission, to a constant velocity joint of a vehicle transmission, both of which are known and illustrated schematically as dashed-line blocks only, for simplicity;

FIG. 2 is a schematic magnified view, also in elevation and longitudinal cross-section, of a detail of the driven wheel hub of a vehicle in FIG. 1;

FIG. 3 is a schematic view in elevation and longitudinal cross-section of a second possible embodiment of a driven wheel hub made according to the present invention;

FIG. 4 is a schematic magnified view in elevation and longitudinal cross-section of a detail of the driven wheel hub of a vehicle in FIG. 3;

FIG. 5 is also a schematic view in elevation and longitudinal cross-section of an end portion of a radially inner annular element forming part of the wheel hub in FIG. 3, and made according to the invention, also showing some critical design measurements of front toothing thereof used for transmitting torque;

FIG. 6 is a pictorial schematic perspective three-quarters front view of part of front toothing for transmitting torque of a wheel hub made according to the invention; and

FIG. 7 is a pictorial view of a circumferential profile of the front toothing in FIG. 6.

### DETAILED DESCRIPTION OF THE INVENTION

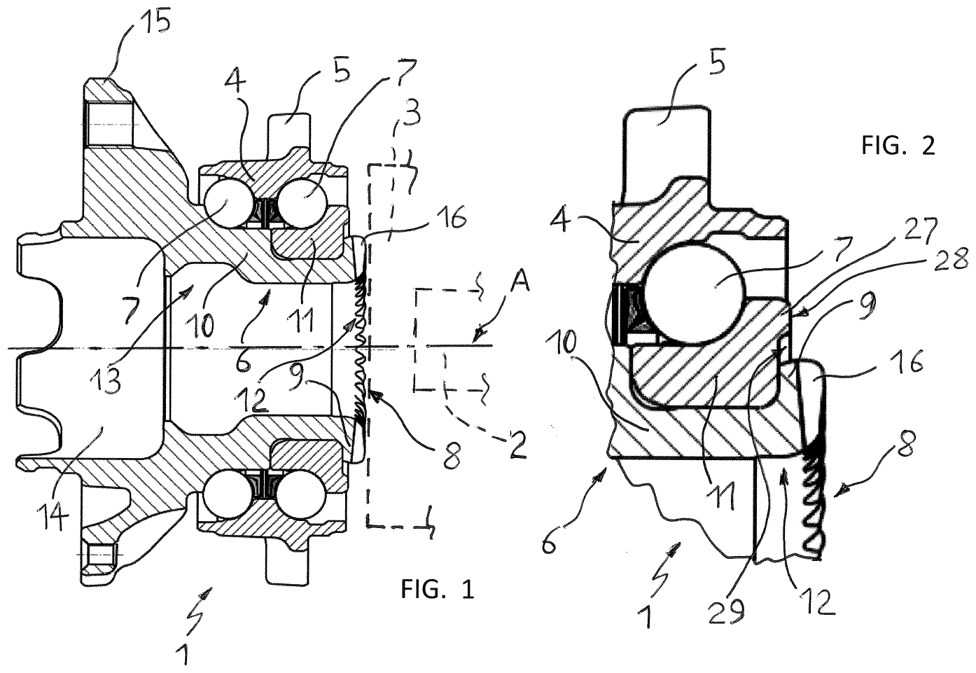

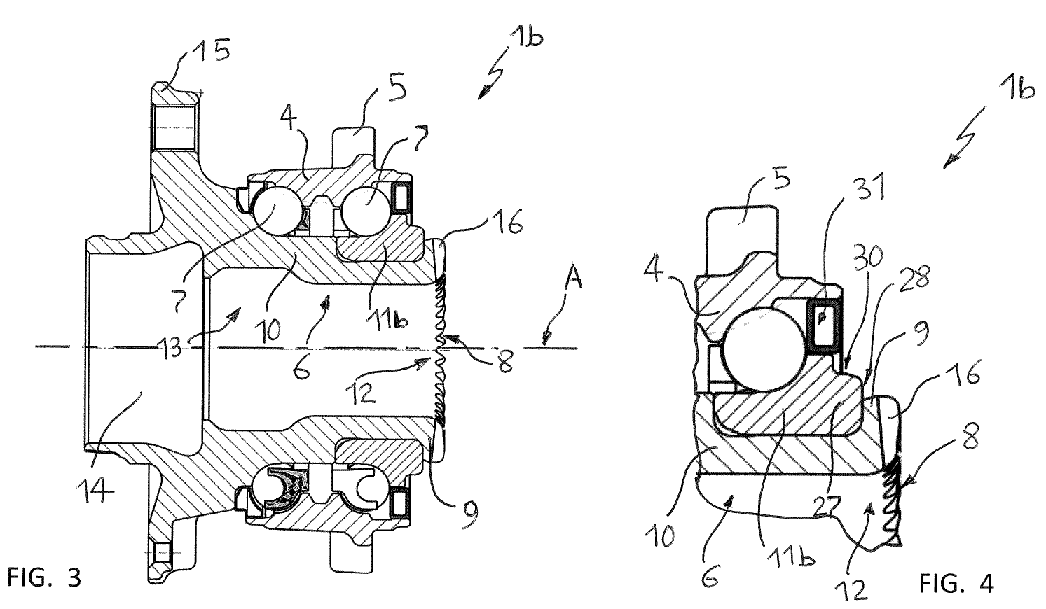

In FIGS. 1 to 7, reference sign 1 (FIGS. 1 and 2) or 1b (FIGS. 3 and 4) is used to denote, as a whole, a driven wheel hub of a vehicle, made according to the present invention, as detailed below.

The wheel hub 1 is designed to receive, when in use, drive torque from a vehicle transmission 2, the transmission 2 being known and shown only schematically by a block in FIG. 1, through a constant velocity joint 3, which is also known, forming part of the vehicle transmission 2, and also shown only schematically as a dashed-line block, for simplicity.

The wheel hub 1b is a possible variant of the wheel hub 1 and is substantially identical thereto, except for a detail described below. Therefore, with the exception of the detail mentioned above and described below, the description of the wheel hub 1 shall also apply to the wheel hub 1b.

The wheel hub 1 comprises an outer ring 4 which is intended, when in use, to be fastened in a known manner to a vehicle suspension upright (not shown), for example by a radially outer flange 5, and an inner ring 6.

The outer ring 4 and inner ring 6 are coupled together in a relatively rotary manner by means of two rows of rolling bodies 7, for example balls, inserted radially between the rings 4 and 6 and engaging a pair of suitable annular raceways formed on the rings 4 and 6, the raceways being known and therefore not described in detail.

The inner ring 6 can be operationally associated, when in use and in a known manner, with the constant velocity joint 3 by means of front toothing 8, preferably obtained or formed using a plastic deformation process, which is known and therefore not described, on an annular collar 9.

The inner ring 6 comprises, in the non-limiting examples shown, a radially inner annular element 10 of the wheel hub 1 and a small inner ring (SIR) or insert 11, which is driven radially onto the outside of a front axial end 12 of the annular element 10.

The radially inner annular element 10 of the wheel hub 1 therefore constitutes at least part of the inner ring 6 of a wheel-hub rolling bearing 13 (FIGS. 1 and 3).

In the non-limiting example embodiments illustrated, the rolling bearing 13 also constitutes the entire wheel hub 1 itself, being designed as a wheel hub unit (of a known type), in which the outer ring 4 is provided with the radial flange 6, while the annular element 10 is provided, at the axial end 14 thereof opposite to the front axial end 12, with a second flange 15 designed to receive a vehicle wheel (which is known and not illustrated, for simplicity).

The radially inner annular element 10 is however always spindle-shaped, even if (in a possible variant which is not illustrated for simplicity and being obvious to a person skilled in the art) it is not part of the rolling bearing 13, in which case the smaller inner ring or “insert” ring 11 (or 11b) would be absent and the inner ring 6 of the rolling bearing 13 would consist of a one-piece annular component coupled with both rows of rolling bodies 7 and simply fitted onto a radially outer lateral surface of the annular element 10, which, again in this case, would nonetheless have two opposing front ends 12 and 14, the end 14 being provided with the flange 15 and the end 12 being provided with the annular collar 9.

In the non-limiting example embodiments illustrated, the radially inner annular element 10 is part of the inner ring 6 of the rolling bearing 13 and the annular collar 9 is obtained by upsetting a portion of the front end 12 against the insert ring 11 (or 11b), axially locking it onto the radially inner annular spindle element 10 of the wheel hub 1 and forming part of the inner ring 6.

The front toothing 8 is in any case always carried by/formed on the annular collar 9, which is carried by/formed on the front axial end 12, which is upset/folded by plastic deformation against the insert ring 11/11b or (in the aforementioned variant, which is not shown) against the entire inner ring 6 of the rolling bearing 13, mounted radially on the outside of the annular element 10.

Furthermore, as mentioned above, the front toothing 8 is designed to couple, when in use, with the mating side face spline/front toothing of the constant velocity joint 3 to transmit torque between the constant velocity joint 3 and the radially inner annular element 10.

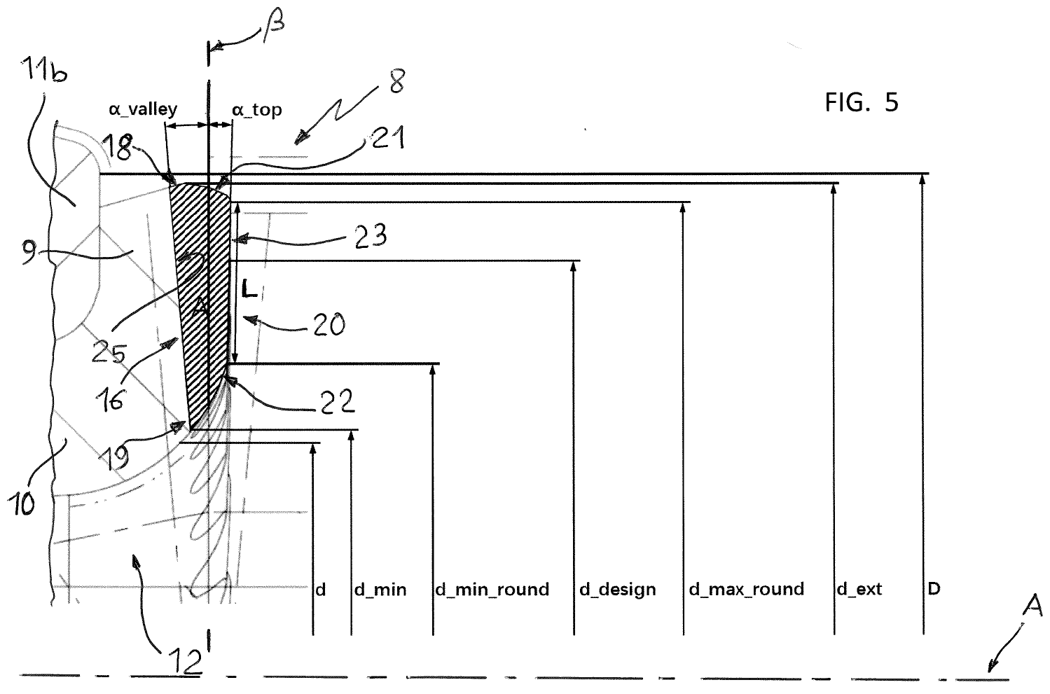

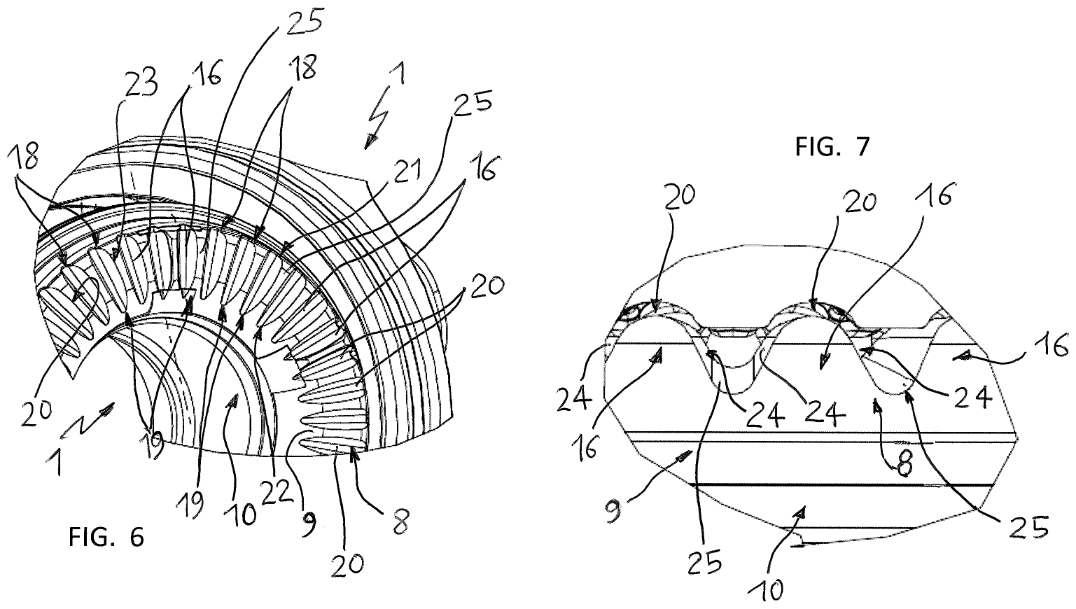

The front toothing 8 for transmitting torque is formed on the first axial front end 12, in this case on the collar 9 thereof, of the annular element 10, and comprises a plurality of radial teeth 16 arranged in a row about an axis of symmetry A (FIGS. 1, 3 and 5) of the annular element 10 and extending radially (FIGS. 5 and 6) between:
a first diameter d_ext of the front toothing 8 delimited by respective first radially outer ends 18 of the teeth 16, and
a second diameter d_min of the front toothing 8, delimited by respective second radially inner ends 19 of the teeth 16.

Furthermore, the teeth 16 are delimited axially (FIG. 5), on the side opposite the side facing the front end 12 of the annular element 10, or on the side opposite the end 14, by respective ridges 20.

With reference to FIG. 5, the ridge 20 of each tooth 16 comprises, in a plane radial to the axis A:
a radially outer, first radial section 21 delimiting the first ends 18 of the teeth 16 and having a first curvilinear profile in radial section, the radial stretch 21 extending radially inwards to a third diameter d_max_round of the front toothing 8, where the teeth 16 have a maximum height measured in an axial direction, i.e. parallel to the axis A;
a radially inner, second radial section 22 delimiting the second ends 19 of the teeth 16 and having a second curvilinear profile in radial section, the radial stretch 22 extending radially outwards to a fourth diameter d_min_round of the front toothing 8, where the teeth 16 have a minimum height measured in an axial direction, i.e. parallel to the axis A; and
a third radial section 23 delimited between the first and second radial sections 21 and 22 and connecting the first and second ends 18, 19 of the teeth 16 to each other.

According to one aspect of the invention, in the third radial section 23, the ridges 20 of the teeth 16 all have, viewed in a radial section, a substantially straight profile, as clearly shown in FIG. 5, of length L.

Furthermore, an important aspect of the invention is that, in combination with the feature above, the first section 18 of the ridges 20 of the teeth 16 is designed so that the ratio between the third diameter and the first diameter of the front toothing 8 is greater than 0.9, i.e. so that the following is true:

d_max_round/d_ext>0.9. [1]

Furthermore, according to another, non-secondary aspect of the invention, in a plane perpendicular and transverse to the axis of symmetry A, in this case represented by the plane of the sheet in FIG. 7, the ridges 20 of the teeth 16, in the entire third section 23, are completely rounded (i.e. substantially without any flats) and preferably form circular arcs connecting together pairs of substantially flat opposing flanks 24 (FIG. 7) of each tooth 16, arranged obliquely so as to converge radially with each other outward and toward the respective ridge 20.

The ridges 20 of the teeth 16 are arranged to form with a plane β perpendicular and transverse to the axis of symmetry A (in this case perpendicular to the plane of the sheet in FIG. 5) and passing through a midpoint (i.e. centerline) of the profile of the second radial section 22 of the ridges 20, a predetermined first angle α_top, which, according to one aspect of the present invention, is preferably between four degrees (4°) and ten degrees (10°).

Furthermore, the front toothing 8 includes a plurality of radial channel-shaped depressions 25 (FIG. 7) which flank each tooth 16 to separate it from the other teeth 16 and are arranged to form with the plane β, which is perpendicular and transverse to the axis of symmetry A and passes through a midpoint of the profile of the second radial section 22 of the ridges 20, a second predetermined angle α_valley, which, according to one aspect of the invention, is preferably also between four degrees (4°) and ten degrees (10°).

Preferably, the profile of the section 22 is designed so that the second predetermined angle α_valley is greater than the first predetermined angle α_top.

The front toothing 8 has a design diameter d_design, shown in FIG. 5, between the first diameter d_ext and the fourth diameter d_min_round of the toothing 8.

According to a further aspect of the invention, the ratio between the second diameter d_min of the front toothing 8 and the design diameter d_design thereof shall be less than 0.65, i.e. the following shall be true:

d_min/d_design<0.65. [2]

Similarly, according to a further aspect of the invention, the ratio between the aforementioned fourth diameter d_min_round of the front toothing 8 and the design diameter d_design of the front toothing shall be less than 0.7; i.e. the following shall be true:

d_min_round/d_design<0.7. [3]

The design diameter d_design is known a priori, as it depends on the torque range or the amount of torque to be transmitted. According to the preferred illustrated embodiments, it can be assumed that the design diameter d_design is substantially equal to the difference between the first diameter d_ext and the length L of the third section 23 of the ridge 20 of the teeth 16. However, the length L shall be measured parallel to the straight profile of the third section 23 of the ridge 20 of the teeth 16 and not perpendicular to the axis A.

With reference now to FIGS. 1 and 2, the radially inner annular element 10 of the wheel hub 1 is preferably, as already mentioned, a spindle-shaped section or portion of an inner ring 6 of a rolling bearing 13 is driven and includes a first annular raceway for rolling bodies 7 and on which an insert ring 11 includes a second annular raceway for rolling bodies 7.

The first front end 12 of the annular element 10 consists of/comprises an annular collar 9 which is upset against the insert ring 11, thereby locking it, and provided with the front toothing 8, which is preferably formed by plastic deformation of the annular collar 9 during upsetting.

According to another, non-secondary aspect of the invention, a first end 27 of the insert ring 11 facing the same way as the first end 12 of the annular element 10 and including a flat front face 28 and an annular shallow recess 29 formed radially inside the flat front face 28 of the insert ring 11.

In combination with this feature, the annular collar 9 is designed to be only partially accommodated within the annular shallow recess 29, engaging radially on the inside thereof with radial clearance and projecting axially out of the annular shallow recess 29 over at least all of the greater height of the teeth 16. This further reduces the axial dimensions of the wheel hub 1 on the one hand, and facilitates meshing of the front toothing 8 with the toothing of the constant velocity joint 3 on the other hand.

The described form of the toothing 8 and the dimensioning thereof based on the critical parameters determined by experimentation by the Applicant's technicians, the torque transmission and the radial extension of the teeth 16 and the extension of the surface of the flanks 24 of the teeth 16 are maximized without increasing the axial and radial dimensions of the toothing 8, compared to similar, conventionally formed toothing.

The correct engagement of the toothing 8 with the toothing of the constant velocity joint 3 is also improved according to the invention on the one hand by the fact that the teeth 16 are designed with a greater radial extension L of the stretch 23 of the fully rounded ridges 20 thereof, and is also maximized by:
a) Reducing the diameter d_min_round where the top of the teeth 16 is already fully rounded: d_min_round/d_design<0.70; and
b) Increasing the ratio between the maximum diameter at which the teeth are rounded and the maximum outer diameter of the front toothing 8: ρ=d_max_round/d_ext>0.90.

Finally, the variant 1b in FIGS. 3 and 4, where details similar or identical to those already described for the embodiment in FIGS. 1 and 2 are denoted for simplicity using the same reference numbers, is identical to the embodiment in FIGS. 1 and 2, except for the insert ring 11, which is replaced by another small inner ring or insert ring 11b of slightly different shape.

In particular, the insert ring 11b also comprises an end 27 delimited by a flat front face 28, but instead of the shallow recess 29, which is absent from this variant, the insert ring 11b has a stepped annular groove 30 formed radially on the outside of the end 27. A known sealing assembly 31 is inserted between the outer ring 4 and the insert ring 11b, and the annular groove 30 is used to accommodate, when in use, a rotational speed detector, which is known and not illustrated for simplicity, precisely at the front toothing 8 for transmitting torque, thus obtaining improved signals.

All of the objectives of the present invention are thus achieved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A radially inner annular element of a wheel hub, the annular element comprising:
an annular body having an axis of symmetry and a first axial front end, a front toothing for transmitting torque formed on the first axial end and including a plurality of teeth arranged in a row about the axis of symmetry and extending radially between a first diameter of the front toothing bounded by first, radially outer ends of the plurality of teeth and a second diameter of the front toothing bounded by second, radially inner ends of the plurality of teeth, each one of the plurality of teeth being bounded axially by a ridge including:
a radially outer, first radial section delimiting a first end of the tooth and presenting in radial section a first curvilinear profile, extending radially inwardly to a third diameter of the front toothing, at which the tooth has a maximum height measured in an axial direction;
a radially inner, second radial section delimiting a second end of the tooth and presenting in radial section a second curvilinear profile, extending radially outwardly to a fourth diameter of the front toothing, at which the tooth has a minimum height measured in an axial direction; and
an intermediate, third radial section bounded between the first and second radial sections and connecting the first and second ends of the tooth;
wherein the ridges of the plurality of teeth have a substantially straight radial profile along the third section;
wherein the first section of the ridge of each one of the plurality of teeth is configured so that a ratio of the third diameter of the front toothing to the first diameter of the front toothing is greater than 0.9.

2. The annular element according to claim 1, wherein in a plane perpendicular and transverse to the axis of symmetry, the third section of each ridge of each one of the plurality of teeth is shaped as a circular arc connecting a pair of substantially flat opposite flanks of each tooth, arranged obliquely so as to converge radially with each other outward and toward the ridge.

3. The annular element according to claim 1, wherein the ridge of each one of the plurality of teeth is arranged to form a predetermined first angle with a plane perpendicular and transverse to the axis of symmetry and passing through a midpoint of the profile of the second radial section of the ridge, the first angle having a value between four degrees and ten degrees.

4. The annular element according to claim 1, wherein the front toothing includes a plurality of radial, channel-shaped depressions, each one of the plurality of teeth being flanked by two of the plurality of depressions so as to separate each one of the plurality of teeth from each adjacent one of the plurality of teeth, each one of the plurality of depressions being arranged so as to form a second predetermined angle with a plane perpendicular and transverse to the axis of symmetry and passing through a midpoint of the profile of the second radial section of the ridge of each one of the plurality of teeth, the second predetermined angle having a value of between four degrees and ten degrees.

5. The annular element according to claim 4, wherein the value of the second predetermined angle is greater than the value of the first predetermined angle.

6. The annular element according to claim 1, wherein the front toothing has a design diameter between the first diameter and the fourth diameter and a ratio of the second diameter to the design diameter is less than 0.65.

7. The annular element according to claim 6, wherein a ratio of the fourth diameter to the design diameter is less than 0.7.

8. The annular element according to claim 6, wherein a value of the design diameter depends on a range of an amount of torque to be transmitted by the toothing and is substantially equal to a difference between the first diameter and a length of the third section of the ridge of each one of the plurality of teeth measured parallel to the straight profile of the third section of the ridge of each one of the plurality of teeth.

9. The annular element according to claim 1, wherein the annular element is part of an inner ring of a rolling bearing including a first annular raceway for rolling elements, an insert ring providing a second annular raceway for rolling elements being disposed on the inner ring, a first front end of the annular element including an annular collar upset against the insert ring so to lock the insert ring on the annular element and provided with the front toothing, the front toothing being formed by plastic deformation of the annular collar, a first end of the insert ring facing a same side as a first end of the annular element, the first end of the insert ring including a flat front face and an annular shallow recess is provided radially inwardly of the flat front face of the insert ring, the annular collar being partially housed radially within the annular shallow recess and projecting axially cantilevering outside of the annular shallow recess.

10. A driven wheel hub connectable with a vehicle transmission to transmit torque from a constant velocity joint having a side face spline, the wheel hub comprising:
a rolling bearing including an outer ring having a radially outer first flange, a plurality of rolling elements, and an inner ring carried by or comprising an annular element according to claim 1 and an insert ring mounted on the annular element;
wherein the annular element is spindle-shaped and has a second flange at a second front end opposite the first front end, the second flange being configured to receive a vehicle wheel, the first front end including an annular collar providing the front toothing configured to couple with the side face spline of the constant velocity joint.
